(19) United States
(12) Patent Application Publication
(10) Pub. No.: US 2002/0105993 A1
(43) Pub. Date: Aug. 8, 2002

(54) Pulsed discharge gas laser having non-integral supply reservoir

(75) Inventor: Fuqian Tang, Orlando, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: T&S Team Incorporated, Orlando, FL (US)

(21) Appl. No.: 10/039,389

(22) Filed: Oct. 29, 2001

Related U.S. Application Data
(63) Continuation-in-part of application No. 09/906,261, filed on Jul. 16, 2001.
Application No. 09/906,261 is a continuation of application No. 09/200,005, filed on Nov. 25, 1998, now Pat. No. 6,263,007.
(60) Provisional application No. 60/079,004, filed on Mar. 23, 1998.

(51) Int. Cl. H01S 3/22; H01S 3/223

(52) U.S. Cl. 372/55

(57) ABSTRACT

A laser assembly includes a lasing medium enclosure for containing a lasing medium. A pumping source stimulates the lasing medium within the lasing medium enclosure. The laser assembly further includes a lasing medium supply reservoir for storing a quantity of the lasing medium therein. The lasing medium includes a fluid outlet and the lasing medium enclosure includes a fluid outlet. A fluid connection is provided between the fluid inlet and the fluid outlet, and at least one fluid seal is associated with the fluid connection.

### RELATED APPLICATIONS

The present application is a continuation-in-part of U.S. patent application Ser. No. 09/906,261 filed Jul. 16, 2001, which, in turn, is a continuation of U.S. patent application Ser. No. 09/200,005 filed Nov. 25, 1998 now U.S. Pat. No. 6,263,007 which is based on Provisional Application Serial No. 60/079,004 filed on Mar. 23, 1998, the entire disclosures of each being incorporated herein by reference.

### BACKGROUND OF THE INVENTION

The general construction of a conventional laser includes three major components: a power supply 10 which is also called the pumping source, an active medium 12, and an optical cavity 14 as diagrammatically illustrated in FIG. 1a. The power supply 10 supplies power necessary to “pump” or stimulate the active medium 12 to amplify light passing through it.

The optical cavity 14 is usually defined by two end mirrors 15 and 16 which are parallel to each other. One of the end mirrors (e.g., mirror 16) is totally reflective, and the other end mirror (e.g., mirror 15) is a partial reflector or a laser beam output coupler. The surfaces of the two mirrors 15, 16 are usually coated with multiple layers of metal and/or dielectric materials so that mirror 16 provides total reflectivity at one end of the cavity, and mirror 15 provides a predetermined degree of partial reflectivity at the other end of the cavity from which the laser light exits the active medium 12.

The laser's cavity-defining mirrors 15, 16 reflect the laser light back and forth through the active medium 12 for amplifying the intensity of light within the cavity. That portion of the light which passes through the partial reflector 15 forms an output laser beam 17. The power supply or pumping source 10 may comprise any of a variety of energy sources, such as, but not limited to, flash lamps, other lasers, or electric power supplies that produce current in semiconductor diodes or plasma discharges in a fluid, such as a gas within the optical cavity. The active medium can comprise a gas, a solid, or liquid.

When the laser architecture is configured as a discharge gas laser structure, it usually requires a continuous gas flow or frequent gas refills as the vacuum components release impurity gases, or the discharge induces chemical reactions to change the gas composition. A sealed gas laser, on the other hand, does not require a continuous flow of lasing gas. While it may require gas refills, the interval between refills may vary from hours to many years. However, a sealed gas laser entails more stringent manufacturing conditions in terms of material choice, cleanness, etc. In addition, the laser structure normally incorporates a gas reservoir to increase the amount of gas to maintain a long laser lifetime.

In continuous flow gas lasers and lasers that can be sealed for a short time, as from a few days to even a few months, there usually is a pressurized gas tank connected with the laser which contains a large amount of lasing gas. In a continuous flow gas laser system, the gas flow connection is typically made through a small orifice so that fresh lasing gas may be continuously supplied through the orifice during laser operation.

When the laser is of the type that is to be sealed for a period of time—hours, days or even months—the connection with the gas tank is isolated by a closed valve during laser operation. Used gas is pumped out at regular intervals when the laser is not in operation, and fresh lasing gas is refilled into the laser. In a long-term sealed laser, there is usually no pressurized tank accompanying the laser system. Any necessary lasing gas refill is performed at the factory because the intervals between refills are long.

In a sealed gas laser structure, the lasing gas supply reservoir and the active gas medium region are openly coupled to each other at all times at equal pressure. The lasing gas supply reservoir's function is to increase the amount of gas of a single gas fill, and hence increase the laser lifetime per gas fill. The pressurized gas tank serves to supply fresh lasing gas continuously or repeatedly to the laser system.

FIGS. 1 and 2 diagrammatically illustrate different configurations of a conventional sealed gas laser. FIG. 1 shows a gas laser structure that does not require fluid cooling, and may comprise a HeNe laser, various ion lasers, conduction or diffusion cooled lasers and optically pumped far infrared lasers. FIG. 2 illustrates a gas laser architecture, such as one using carbon monoxide or carbon dioxide as the active medium, that requires fluid cooling (such as through the flow of water or an antifreeze solution), usually through an arrangement of cooling tubes or jackets 29 closely integrated with the active laser bore 23 and/or the pumping source.

In each of these laser architectures, the active medium of the laser comprises a lasing gas 21 that is present within a central region, channel or bore 23 of an enclosure 25, that also includes a lasing gas supply reservoir 27 surrounding and openly coupled with the central active region bore. The lasing gas 21 can be pumped by an electrical discharge, either longitudinally or transversely, or can be pumped by optical irradiation. Cavity mirrors are shown at 26 and 28.

In a conventional cooled discharge laser architecture, since the lasing gas reservoir is integrated with the active laser medium components, the structure has a relatively complex design and a relatively large cross-sectional dimension. This gives rise to substantial technical complexity in the design of the laser. One problem is the fact that the straightness or linearity of the active laser bore 21 is not easy to maintain when the design is complex. Another problem is that the materials must have closely matched rates of thermal expansion.

In the case of direct current (DC) discharge, the gas discharge electrical impedance of a volume of discharging gas is negatively dynamic, and decreases as the discharge current increases. For a continuous wave (CW) DC discharge, the electrical current must be actively stabilized due to the negative impedance. Otherwise a run-away or oscillation of the discharge will occur. This means that the DC power supply must employ a feedback control mechanism to monitor the electric current dynamics. Using this feedback, the power supply is able to quickly adjust the output voltage to reverse at the onset of current run-away. Unfortunately, an electric power supply with feedback and adjustment is relatively difficult to design and expensive to manufacture.

To help stabilize the CW DC discharge, a high resistance ballast resistor is placed in series with the gas discharge since the voltage drop across the resistor will reduce the tendency of discharge run-away or oscillation. For example, when the discharge current is increasing at the same time as the gas discharge impedance is decreasing rapidly, the higher current will cause the voltage drop on the ballast resistor to increase. The voltage on the gas discharge section will then decrease, reversing the increase in current trend. A drawback in using a ballast resistor is that a large amount of energy is converted into wasted heat in the ballast resistor. In a short pulsed discharge, run-away or oscillation is not a problem. Run-away or not, each pulse ends very quickly prior to damaging the power supply or anything else.

In a pulsed laser, the laser medium is excited by pulsed pumping so that the laser output will also be pulsed. The laser pulse duration will not necessarily be the same as that of the pumping pulse. In particular, the laser pulse has a minimum duration. This means that the laser output will stay at a constant duration even when the pumping pulse duration is considerably shorter than the minimum laser pulse duration. The minimum intrinsic laser pulse duration is dependent only on characteristics of the laser design, such as the gas pressure and the cavity configuration, for example.

A linearly polarized laser beam is needed in many applications. Mechanisms to provide a polarized laser output beam include the use of a Brewster window, a wire Grid, a brazed grating, for example. Each of these mechanisms usually requires the installation of an additional component to constrain the laser beam to be polarized. The additional component adds expense, complexity and space to the laser device. It also introduces additional loss to laser light amplification resulting in lower laser output power. A TEM₀₀ mode laser produces a single spot laser beam, also called a fundamental Gaussian mode laser beam. This laser mode is frequently desirable because of its high energy concentration, coherence and stability.

### SUMMARY OF THE INVENTION

In view of the foregoing background, an object of the present invention is to provide a laser assembly laser that has a relatively straightforward design.

This and other objects, advantages and features in accordance with the present invention are provided by a laser assembly comprising a lasing medium enclosure that is physically separate from but in fluid communication with a lasing medium supply reservoir using at least one fluid seal associated with the fluid connection. Since the lasing medium enclosure and the lasing medium supply reservoir can be made separately and of different materials, both may have relatively straightforward structural configurations, thereby significantly reducing their manufacturing cost.

In particular, the laser assembly comprises a lasing medium enclosure for containing a lasing medium, and a pumping source for stimulating the lasing medium within the lasing medium enclosure. The lasing medium enclosure also includes a fluid inlet. The laser assembly further includes a lasing medium supply reservoir for storing a quantity of the lasing medium therein. The lasing medium supply reservoir also includes a fluid outlet. A fluid connection is preferably between the fluid inlet and the fluid outlet, and at least one fluid seal is associated with the fluid connection.

The lasing medium enclosure may further comprise a mirror mount having a passageway therethrough, and a lasing medium tube having an open end connected in fluid communication with a first end of the passageway so that a second end of the passageway defines the fluid inlet. The laser assembly may further comprise a cooling structure thermally coupled to the lasing medium enclosure, with the cooling structure comprising at least one cooling fluid inlet and at least one cooling fluid outlet at different locations along the lasing medium enclosure.

The use of a fluid seal allows the lasing medium enclosure and the lasing medium supply reservoir to be manufactured separately and then connected by the fluid seal. The lasing medium enclosure and the lasing medium supply reservoir may be arranged in spaced apart relation or they may be arranged in nested relation. The lasing medium preferably comprises a gas or a liquid.

The fluid connection may comprise a tube having a first end connected to the fluid outlet and a second end connected to the fluid inlet. Consequently, first and second fluid seals may be associated with the respective first and second ends of the tube. The tube may comprise rigid material. In lieu of a tube, the fluid connection may be defined by the fluid inlet and the fluid outlet being positioned in an end-to-end relation with a fluid seal positioned therebetween.

Each fluid seal may comprise an o-ring, an adhesive or a heat softenable metal material. The o-ring may include rubber, plastic or metal. The heat softenable metal material may include brazed, soldered or welded metal or metal alloys. In addition, the lasing medium enclosure may comprise a first material and the lasing medium supply reservoir may comprise a second material different than the first material.

Another aspect of the present invention is directed to a method for making a laser assembly comprising providing a lasing medium enclosure containing a lasing medium, coupling a pumping source to the lasing medium enclosure for stimulating the lasing medium, and providing a lasing medium supply reservoir storing a quantity of the lasing medium therein. The lasing medium enclosure also includes a fluid inlet, and the lasing medium supply reservoir also includes a fluid outlet. The method preferably further comprises establishing a fluid connection between the fluid inlet and the fluid outlet and using at least one fluid seal associated therewith.

### BRIEF DESCRIPTION OF THE DRAWINGS

FIG. 1 diagrammatically illustrates a conventional sealed gas laser having a gas reservoir without a cooling jacket in accordance with the prior art;

FIG. 1a diagrammatically illustrates the components of a conventional sealed gas laser in accordance with the prior art;

FIG. 2 diagrammatically illustrates a conventional sealed gas laser having a gas reservoir and a cooling jacket in accordance with the prior art;

FIG. 3a diagrammatically illustrates a gas laser having a gas reservoir separate from the laser's cooling jacket and active medium in accordance with the present invention;

FIG. 3b diagrammatically illustrates a gas laser having a gas reservoir separate from the laser's active medium and without a cooling jacket in accordance with the present invention;

FIGS. 4a-4c diagrammatically illustrate a gas laser having separate gas reservoirs packed together with the laser tubes/bores of the active medium, and mirror mounts and mirrors supported by the tubes of an active medium (laser bores) or on the reservoirs in accordance with the present invention;

FIG. 4d diagrammatically illustrates a gas laser having an integrated gas reservoir with an active medium with a simplified structure due to the use of a flexible thin tubing for the fluid connection in accordance with the present invention;

FIGS. 5a-5c diagrammatically illustrate compact folded cavity gas lasers having separate gas reservoirs in accordance with the present invention;

FIG. 6a is a timing diagram showing short electrical discharge pulses in accordance with the present invention;

FIG. 6b is a timing diagram showing laser pulses with intrinsic duration associated with the electrical discharge pulses of FIG. 6a;

FIG. 7a is a timing diagram showing a rapid pulse train of electrical discharge pulses in accordance with the present invention;

FIG. 7b is a timing diagram showing a laser output as a continuum in association with the rapid electrical discharge pulse train of FIG. 7a, in which the laser pulses merge together;

FIG. 8 shows a set of respectively different patterns of mirrors that will induce a polarized laser output in accordance with the present invention;

FIG. 9 shows a set of different stepwise and tapered active medium volumes for selecting the TEM₀₀ mode;

FIGS. 10a and 10b show respective examples of a double jacketed laser cooling architecture having cooling fluid inlets and fluid outlets at different places along the axis of the laser in accordance with the present invention;

FIG. 11 diagrammatically illustrates a laser assembly with the fluid connection being provided by a rigid tube between the lasing medium enclosure and the lasing medium supply reservoir in accordance with the present invention;

FIG. 12 diagrammatically illustrates a laser assembly with the lasing medium enclosure and the lasing medium supply reservoir in an end-to-end relation in accordance with the present invention; and

FIG. 13 diagrammatically illustrates a laser assembly with the lasing medium enclosure and the lasing medium supply reservoir in a nested relation in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notations are used to indicate similar elements in alternative embodiments.

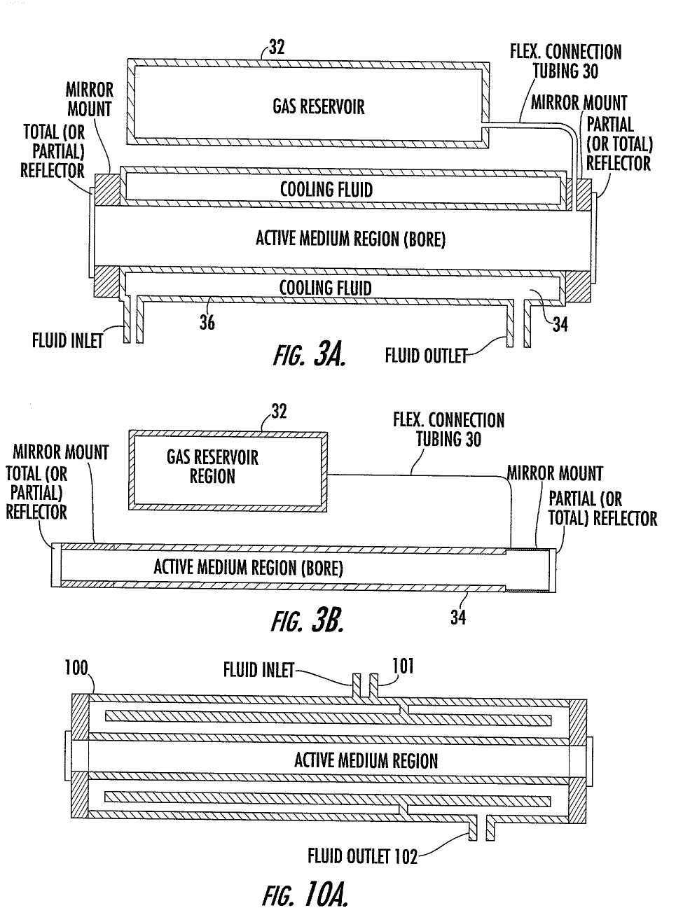

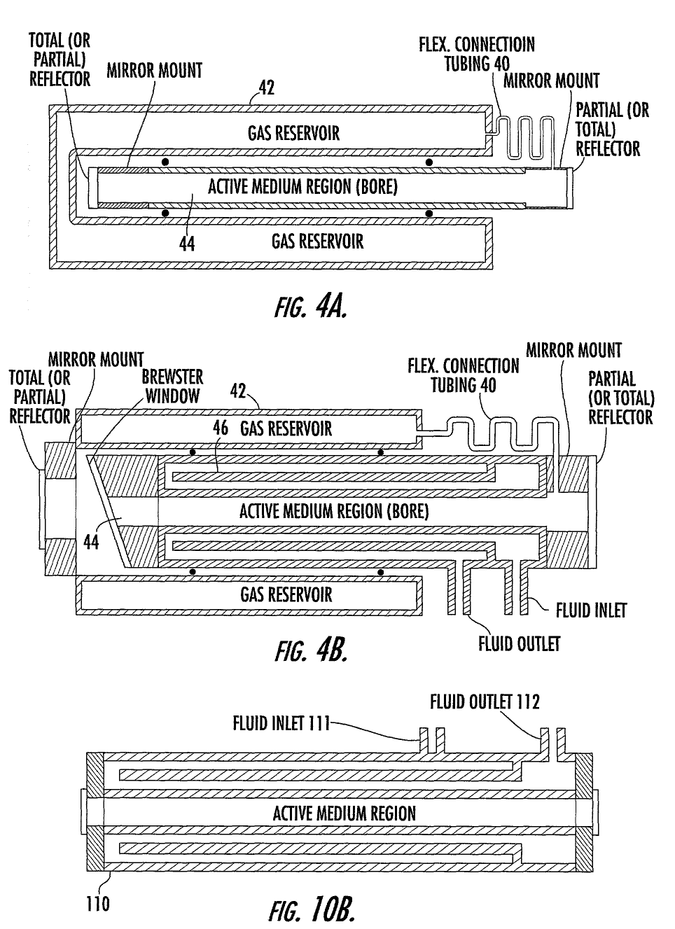

Reference is now directed to FIGS. 3a, 3b and 4a-4d, which diagrammatically illustrates a first aspect of a gas laser in accordance with the present invention, in which the lasing gas supply reservoir is separated from the active gas medium by a flexible or semi-flexible tubing. As shown therein, respective lengths of flexible tubing or conduit (shown at 30 in FIGS. 3a and 3b and 40 in FIGS. 4a-4d) are used to provide a lasing medium (gas) connection between one or more lasing gas supply reservoirs 32, 42 and laser bores 34, 44. The length of the lasing gas supply tubing can have many configurations and sizes. FIGS. 3a and 4b also show respective cooling fluid structures 36, 46 surrounding the laser bores 34, 44.

As a non-limiting example, the gas supply tubing sections 30, 40 may comprise highly flexible capillary metal tubes having outer diameters ranging from 0.1 mm to 5 mm. High purity and cleanness plastic tubing made of a material such as Teflon may also be employed. A first material may be used for the laser bore or tubing enclosing the active gas medium, while another material may be used for the reservoir that contains most of the gas. For example, glass or ceramic may be used for the active medium bore, and extruded metal may be used for the lasing gas supply reservoir.

FIGS. 3a and 3b show the lasing gas supply reservoirs 32 physically separated from the active medium 34. The separation distance between the two can be short or long. FIGS. 4a-4c show laser configurations in which the lasing gas supply reservoirs 42 and the laser active medium bores or tubes 44 are arranged in a spatially “nested” arrangement or “packed together” arrangement. Although packed together, the reservoirs 42 are still built separately from the laser bores or tubes 44, thereby simplifying the design and manufacturing process.

FIG. 4d diagrammatically illustrates a laser configuration in which the laser active medium 44, cooling fluid (water jacket) 45, and gas reservoir 42 are integrated together. The structural configuration of this gas laser is simpler than the conventional gas laser structure of FIG. 2, since the gas reservoir 42 and active medium 44 do not need to be in fluid communication, since the fluid connection is effected by a section of thin flexible tubing 40.

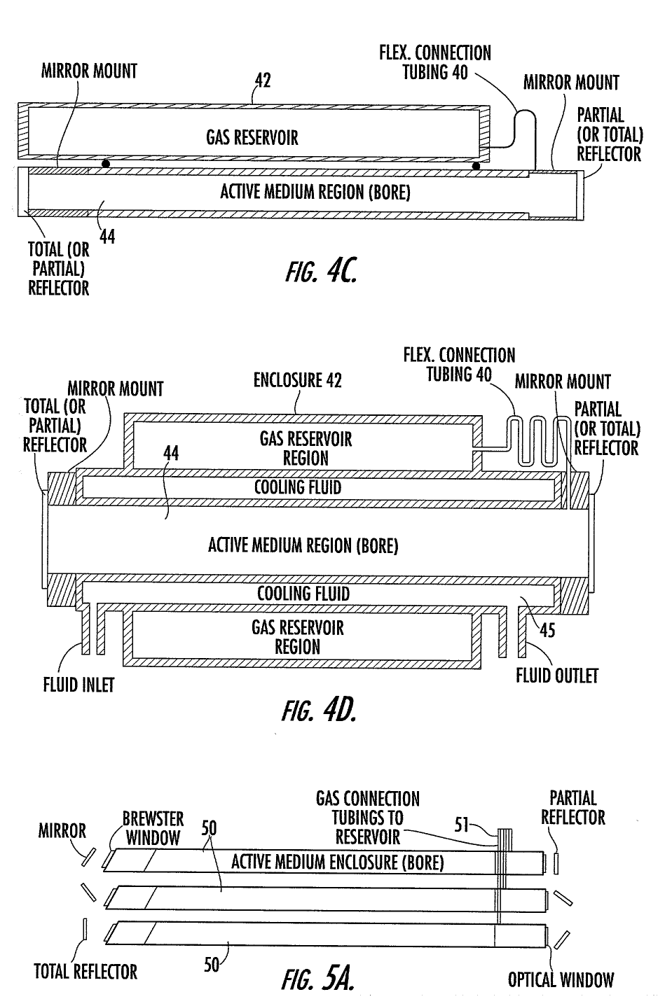

FIGS. 5a-5c show arrangements of relatively “slender” or generally longitudinally (e.g., narrow cylindrically) configured gas tubes 50 for containing the active lasing gas medium. Because of their relatively slender shape, a plurality (e.g., two to a very large number) of lasing gas bores or tubes can be packed together to form a compact “folded” laser arrangement. Lasing gas supply conduits 51 couple the lasing gas bores to their associated gas reservoir(s). In FIGS. 5a and 5b, the cooling jackets, the coolant inlets and outlets, and the lasing supply gas reservoirs are not shown for simplicity and clarity. FIG. 5c also shows the laser bores or tubes 50 arranged without the reservoir, the mirrors, or the coolant components. Although round or cylindrically shaped laser bores are shown as non-limiting examples, other bore configurations such as lasing gas tubes having a regular or irregular polygonal shape may be employed.

Among the advantages of the above configurations for separating the lasing gas supply reservoir from the active laser bore is simplicity, thereby reducing cost as compared to a conventional design. The lasing gas supply reservoir may be located in the power supply unit, or in the cooling subsystem, etc., with the reservoir-to-bore connection tubing following a path along electrical wires or coolant supply hoses. Because the lasing gas supply tubing allows the lasing gas reservoir to be located apart from the laser's active gas medium (laser bore), namely at a location where there usually is ample space, it can be built to a relatively large size for extended laser lifetime.

The laser bore can be configured to have a very slender shape, so that it can be placed on an articulated delivery arm. Also, due to its greatly reduced size and weight, the laser bore can be mounted on a moving platform or arm of a beam scanner, thereby obviating the need to move a workpiece upon which the laser beam is incident. The reduced size and weight of a slender laser bore also allows an operator to more comfortably hold the laser when the laser is configured as a hand-held device. This coupled with the fact that a large reservoir is employed greatly increases the lifetime of the laser without having to increase the weight and size of what is held in the operator's hand.

Since the laser bore and its gas supply reservoir can be made separately and of different materials, both may have relatively straightforward structural configurations, thereby significantly reducing their manufacturing cost. In the configurations of FIGS. 4a and 4b, a mechanically stable material is preferably used for constructing the gas supply reservoir when supporting the active gas medium and the mirror mounts, thereby improving the stability of the laser output.

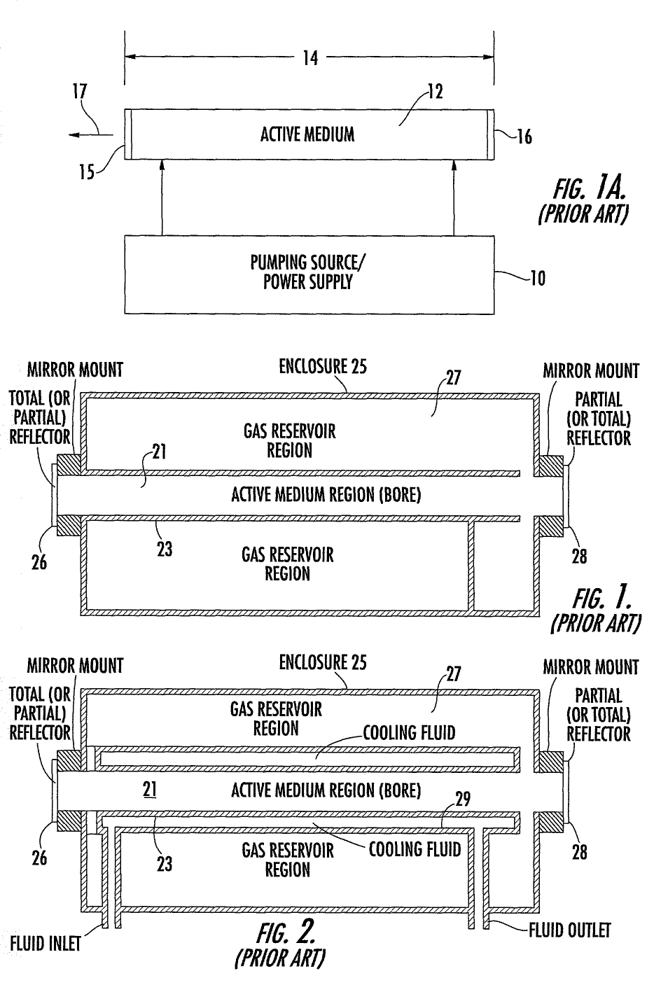

A laser having the folded laser design configuration, such as shown in FIGS. 5a-5c, readily lends itself to being manufactured at a relatively low cost, since each laser bore 50 is a very simple and inexpensive part, as is the lasing gas supply reservoir or reservoirs. Also, the folded laser design provides for a very compact architecture since each bore 50 has a relatively slender or narrow shape. In contrast, if the prior art structures of FIGS. 1 or 2 were used to build a folded laser architecture, the resulting design would be considerably bulkier than those shown in FIGS. 5a-5c. It may also be noted that although a single lasing gas supply reservoir may be coupled to each of the bores 50 of a multiple laser bore configuration, more than one reservoir may be used. For example, each bore may be supplied from its own dedicated lasing gas supply reservoir.

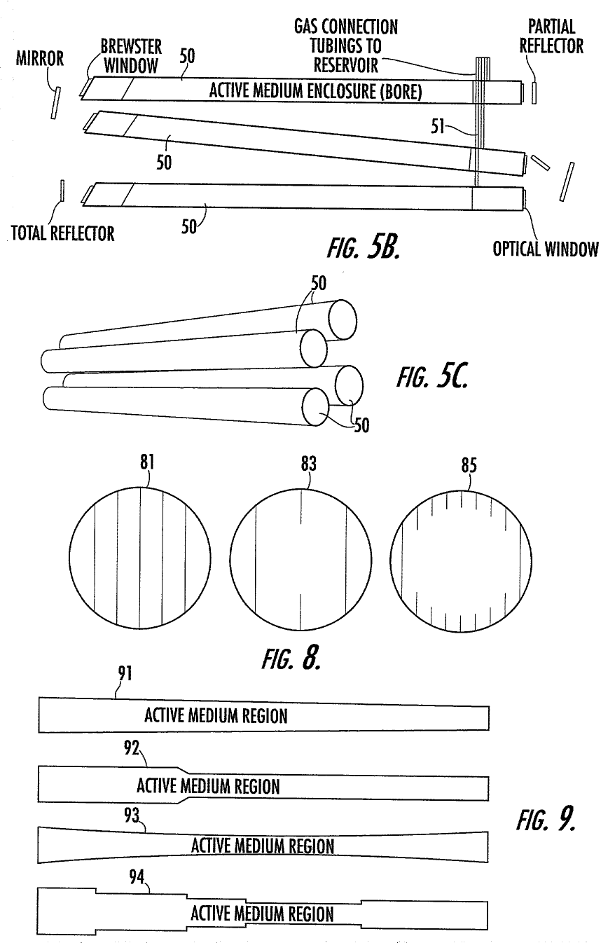

In the operation of the pulsed gas discharge laser for producing a continuous laser output, alternating negative and positive polarity current pulses diagrammatically illustrated at 61 and 62 in FIG. 6a may be applied to anode and cathode terminals, respectively, of the gas discharge tube to produce the laser pulses shown at 63 in FIG. 6b. As a non-limiting example, the negative and positive polarity current pulses have a square wave shape.

Since the duration of each electrical discharge pulse is considerably shorter than that of the laser intrinsic pulse duration, as shown in FIG. 7a, the repetition rate of the electrical discharge pulses 71 can be relatively high without completely merging the adjacent electric discharge pulses together. Yet, the laser pulses merge into a continuum or continuous wave (CW) beam output, shown at 72 in FIG. 7b. It will be readily understood to those skilled in the art that electrical current pulses and laser pulses may have a variety of shapes different from those shown in FIGS. 6a and 7a.

When the electrical discharge pulses have a very short pulse duration, it is not necessary to actively stabilize the discharge in the case of DC discharge, since the discharge ends quickly before major run-away occurs. In this pulsed discharge embodiment, a relatively straightforward DC electrical power supply may be employed, since there is no need to actively stabilize the discharge. A continuous wave laser output can be made to have the same output power level as that of a similar laser pumped by continuous electrical current, by simply making each pulse of electrical current a high energy pulse.

Among the advantages of producing a continuous wave laser output by the use of pulsed electrical discharges are the following. The architecture does not require a current-stabilization feedback circuit in the power supply using a ballast resistor to save energy and reduce the wasted heat generation problem. In addition, discharge run-away and oscillation caused by negative impedance electrical efficiency cost is avoided as a result of the simplified power supply design. This advantageously allows a rapid laser on and off modulation. Also, the size of the power supply can be reduced so that it can be more easily integrated into the housing of the active medium and/or lasing gas supply reservoir.

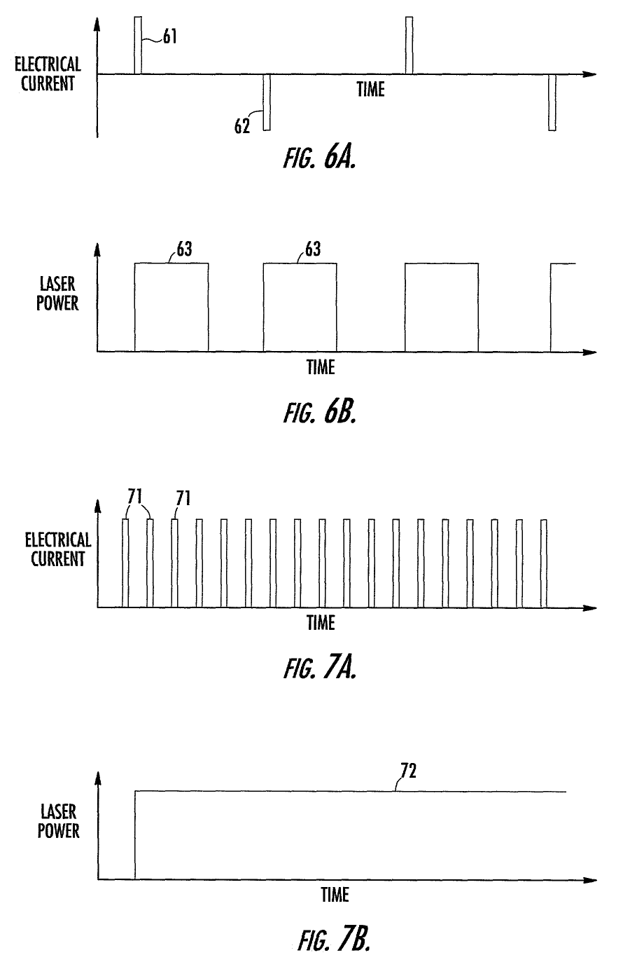

As described briefly above, a set of relatively fine, linear polarization-defining lines may be formed on either or both of the laser cavity mirrors so that the laser output beam will be constrained to have linear polarization. FIG. 8 shows a set of respectively different line patterns 81, 83 and 85 that can be coated on mirrors for inducing a linearly polarized laser output beam. The linear polarization effect is due to the fact that linearly polarized light in a given direction with respect to the direction of the lines will have a higher reflectance than that of light polarized perpendicularly.

The patterns of linear polarization constraining lines may be formed, for example, by etching or cutting away a set of straight lines or grooves in the metal coating material that defines the reflective surface of a laser cavity mirror. If dielectric coatings are formed on the metal coatings, the dielectric coatings can either cover the lines in the metal surface, or have grooves or lines aligned with the lines in the mirror's metal coating.

The reflection of light from the cavity mirror's metallic surface coating results from the oscillation of free electrons induced by the electromagnetic field of the light. Since, in the vicinity of the lines, electrons cannot move and oscillate perpendicular to the lines due to the absence of metal, reflection is low for light having polarization perpendicular to the lines. On the other hand, reflectance is virtually unaffected for light polarized parallel to the lines, where the widths of the lines are narrow. The widths of the lines are preferably near the laser light wavelength. Thus, the direction of polarization of the laser output beam will be parallel to the lines.

In most cases, lines formed in the outer surface region of the mirror coating are sufficient to cause the laser light beam to be linearly polarized. It is advantageous and preferred to have the lines formed in the outer surface region, since the laser beam intensity in this region is relatively low. This thereby reduces the power loss absorbed by the lines. A principal advantage of employing the linear polarization mirror line scheme of the invention is the fact that it eliminates the need for Brewster windows, wire grids, gratings or other polarizing elements that would otherwise increase laser size, complexity and cost.

FIG. 9 shows a set of four non-limiting examples of respectively different stepwise and tapered active medium enclosure volumes 91-94 for defining the laser output mode as a TEM₀₀ mode. The TEM₀₀ mode has the lowest loss compared with other laser modes. The high losses of the other modes prohibit effective amplification of their light intensities. This causes the TEM₀₀ mode to become the dominant mode. The use of a stepwise or tapered enclosure applies for both gas and non-gas lasers. The stepwise or tapered volumes of active media is designed in accordance with the TEM₀₀ Gaussian beam profile, as determined by the laser cavity structure so as to limit light amplification of other modes that have different and unfit profiles. Among the advantages of the use of a stepwise or tapered enclosure is the fact that it eliminates the need to otherwise employ a complicated mirror coating design or intra-cavity apertures for selecting the TEM₀₀ mode.

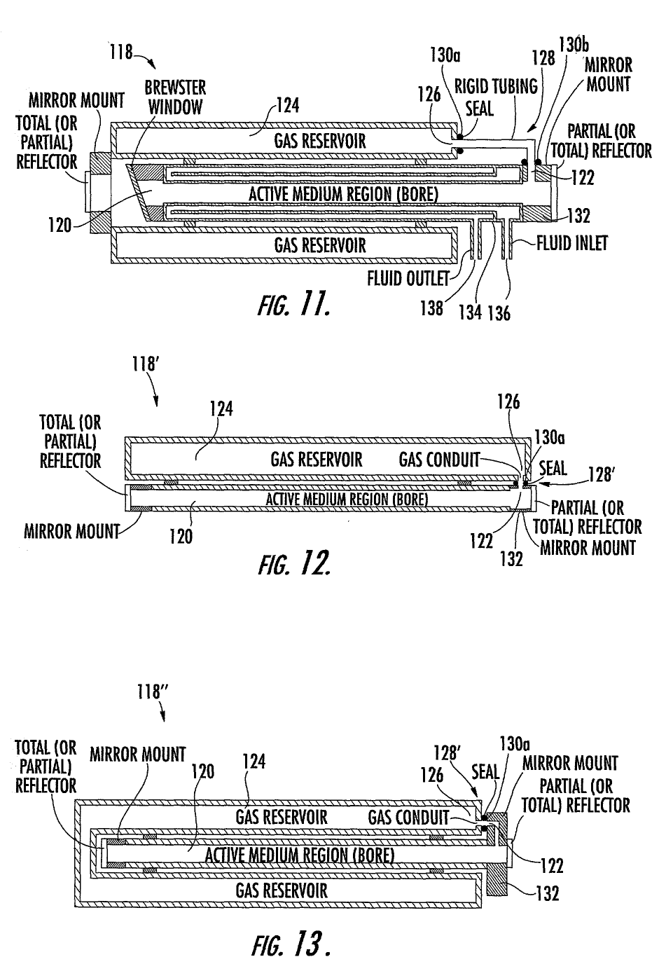

FIGS. 10a and 10b shows respective examples of multiple (e.g., double) jacketed laser cooling architectures 100 and 110 that provide for placement of cooling fluid inlets 101, 111 and cooling fluid outlets 102, 112 at respectively different locations along the axis of the laser's active medium region, i.e., optical cavity. By using a multiple cooling jacket structure, the cooling fluid inlet and outlet can be placed anywhere along the length of the bore/cavity containing the active laser medium.

In a first, non-limiting example of the invention, a relatively low cost, long lifetime, sealed CO₂ gas laser operating in a power range of 10 to 100 W may be constructed using a single straight discharge tube. The discharge tube, which also contains the active medium, may be made of glass, ceramic, metal and the like. The length of the discharge tube may be on the order of five to one hundred inches, depending upon the output laser power required. The cross-sectional dimension (diameter for a cylindrical tube) typically may range from 0.5 to 7 mm in the case of a waveguide laser, or up to 20 mm in the case of a free space laser. By not integrating the gas reservoir with the laser discharge structure, it is possible to manufacture the discharge laser tube at a fraction of the cost of a conventional laser discharge tube.

A separated gas reservoir 32 may be employed, as diagrammatically illustrated in FIG. 3, using the same or different materials as that of the discharge tube. A relatively straightforward formation technique is to use an extruded metal tube, such as an extruded aluminum tube. An extruded aluminum tube, such as one having a square or round cross section, may be closed by plates at its two opposite ends, as by welding, using an o-ring seal or by gluing to form a hollow chamber as the gas reservoir. The connection between the discharge tube and the gas reservoir may be effected by a section of stainless steel tubing or other metal tubing having an outer diameter on the order of 0.5 to 2 mm for relatively high flexibility.

The gas reservoir may also support the discharge tube as shown in FIG. 4. In this “nested” configuration, the connector tubing 40 may be made thicker with less flexibility, up to several millimeters in diameter, for example, since the discharge tube and the reservoir do not undergo significant relative movement once the laser is fabricated. Whether the reservoir is separate from or formed together with the discharge tube, the cost of the reservoir is low since it has a relatively basic structural configuration. Extruded aluminum, for example, which is a widely available and relatively low cost material, may be employed.

For CO₂ lasers operating in a 10 to 100 W power range, for example, the discharge tube must be cooled. To cool the discharge tube without the use of a coolant fluid as described above, the discharge tube may be placed in contact with a heat conducting and dissipating material, such as one or more finned aluminum blocks. This technique is especially effective for lower power CO₂ lasers operating at or below 100 W.

Another method is to use a coolant flow arrangement such as that illustrated in FIGS. 3a or 4d. A third method, illustrated in FIGS. 4b and 10 and as described above, allows the manufacturer to arbitrarily locate the coolant inlet and output ports. For DC discharge CO₂ lasers, the coolant flow rate can be as low as 1/20 a gallon per minute (GPM) for a 10 W output, or ¼ GPM for a 100 W output.

For the discharge mechanism any of a variety can be employed, such as but not limited to a conventional CW discharge to produce a CW laser output, and a pulsed discharge to produce pulsed discharge using either (longitudinal) DC (direct current), RF (radio frequency), microwave, transverse DC pulsed or other forms of discharge.

In the case of a DC discharge, the discharge can be pulsed at a high frequency to produce a CW laser output so that the power supply can have a simpler design. The intrinsic pulse duration is dependent mostly on the gas pressure. For a laser at 30 Torr gas pressure, the intrinsic pulse duration may be on the order of 100 to 200 μs. With a pressure of 100 Torr, the intrinsic duration is on the order of 20 to 50 μs. At a 30 Torr pressure, for example, the pulse repetition rate should be greater than 5 to 10 KHz to produce a CW output. The discharge pulse duration should be below the period, i.e., inverse of the repetition rate, so that the discharge pulses remain separate pulses.

For a longitudinal laser discharge tube, the discharge current may range from 0.1 to 100 mA, depending on the diameter of the discharge tube, and the power output. For example, a 5 mm bore discharge tube requires on the order of 20 mA for full power output, or 1 mA for reduced output power. For transverse discharge tubes, the current is at much higher level and typically is pulsed.

The dimensions of the discharge tube may vary as needed. For example, for the case of a TEM₀₀ mode, the active medium (discharge tube) may be configured as shown in FIG. 9. For glass tubes, short tubes of different diameters can be joined together to form a stepwise tube configuration. The joints between the tubes are easily made by first heating the ends of tubes with a blowtorch to melt the glass and then join them together. One can also easily make the tapered discharge tube by utilizing a standard glass tube technique wherein a glass tube is formed over a mandrel. In this case, the mandrel may be configured as a tapered rod. After the glass tube is melted and formed on the mandrel, the mandrel is cooled to shrink to a smaller size, and then pulled out of the glass tube.

Also, ceramic or metal discharge tubes may be either machined or preformed as varying diameter tubes. The amount of diameter variation is dependent on the Gaussian laser beam profile, which is dependent on the laser cavity configuration. Calculating the Gaussian beam profile based on the cavity structure, one can easily determine the variation in the diameter of the discharge tube. The cavity structure includes the radii of curvature and spacing of the mirrors, the laser's total reflector mirror and its partial reflector mirror.

When a polarized laser output is needed, a polarizing mirror design as described above may be used. For a CO₂ laser, the lines shown in FIG. 8 can be formed either as a discontinuous (missing) metal coating on the total reflector mirror, which usually has a continuous metal coating, or added metal coating lines on the partial reflector, which conventionally has no metal coating. In the case of missing metal lines on the total reflector, the polarization direction of the laser beam will be parallel to the lines. In the case of added metal lines, the polarization direction will be perpendicular to the metal lines.

A spacing of 0.5 to 10 mm between the lines is sufficient to polarize the laser beam. Generally, a large spacing up to 10 mm may be used for larger discharge bores. While higher density lines (below 0.5 mm) may be more effective in polarizing the beam, they may introduce a loss unless the line width is less than the wavelength, i.e., below 10 μm. The line width should be as narrow as possible for low loss introduced to the laser oscillation, i.e., amplification by the active medium. From a practical standpoint, a line width in the range of 5 to 0.5 mm is sufficient. While a 0.5 mm width will not cause too high a loss for a large bore having a long discharge length and high output laser power, it may subject the mirror(s) to a substantial heating.

The gas pressure will typically vary with the diameter of the discharge tube for both longitudinal and transverse discharge tubes. For a longitudinal DC, RF or microwave discharge tube, the gas pressure may be in a range of 5 to 250 Torr, depending on the diameter. For example, the optimal pressure for a 3 mm discharge bore is 70 to 100 Torr. The optimal pressure for a 10 mm bore is 15 to 40 Torr. For a transverse, short pulsed DC discharge, the pressure may be from about 300 Torr to above atmospheric pressure, i.e., over 760 Torr.

The gas composition of a CO₂ laser gas mixture primarily includes helium (He), nitrogen (N₂) and carbon dioxide (CO₂). Active carbon dioxide molecules at a prescribed high energy level are the active medium for producing laser radiation, thus, the name CO₂ laser. Helium is employed for conducting heat to the wall of the tube, and therefore for cooling the electrical discharging gas mixture. Nitrogen is used to efficiently transfer the electrical energy in the discharge to the carbon dioxide molecules. Typically, carbon dioxide gas has about 4 to 20% concentration, and most commonly near 15%. Nitrogen has about 10 to 20% concentration, and most commonly near 15%. The remaining gas is almost all helium. A small amount of a few different gases, e.g., 5% or less all together, can be added to sealed CO₂ lasers to prolong the lifetime thereof.

The laser's wavelength may be fixed at a predetermined value within a 9 to 11 μm range and is typically at 10.6 μm for the highest output power, or it may be tuned in the range of 9 to 11 μm when at least one grating or prism is used.

A second, non-limiting example of the invention will now be discussed using the parameters of the first example described above. A low cost folded cavity 10 to 500 W CO₂ laser can be constructed as shown in FIG. 5. For example, a low power folded CO₂ laser, e.g., at 25 W, may be used for applications where a short laser is needed, such as a 25 W CO₂ laser having a single discharge tube that might be too long to be used as a hand-held laser. In a folded configuration, the laser may be short enough and small enough to be hand-held, while its sealed-off gas reservoir is located separately away from the laser head.

Fabrication of a folded laser cavity is difficult, even where one is skilled in routinely building single discharge tube lasers. The difficulty results from the fact that there are more mirrors involved, and the mirror alignment becomes very difficult. The more discharge tubes used, the more mirrors required. This increases manufacturing and assembly complexity. Proper instrumentation can facilitate and expedite the folded cavity alignment.

Referring now additionally to FIGS. 11-13, other embodiments of the present invention will now be discussed. The illustrated laser assembly 118 in FIG. 11 comprises a lasing medium enclosure for containing a lasing medium and comprising a fluid inlet 122, and a pumping source 10 (FIG. 1) for stimulating the lasing medium within the lasing medium enclosure. The laser assembly 118 further includes a lasing medium supply reservoir 124 for storing a quantity of the lasing medium therein and comprises a fluid outlet 126. A fluid connection 128 is between the fluid inlet 122 and the fluid outlet 126, and at least one fluid seal 130a, 130b is associated with the fluid connection.

The lasing medium enclosure 120 further includes a mirror mount 132 having a passageway 47 therethrough, and a lasing medium tube having an open end connected in fluid communication with a first end of the passageway so that a second end of the passageway defines the fluid inlet 128. The laser assembly 118 may further comprise a cooling structure 134 thermally coupled to the lasing medium enclosure 120, with the cooling structure comprising at least one cooling fluid inlet 136 and at least one cooling fluid outlet 138 at different locations along the lasing medium enclosure.

The use of the fluid seals 130a, 130b allows the lasing medium enclosure 120 and the lasing medium supply reservoir 124 to be manufactured separately and then connected by the fluid seals 130a, 130b. The lasing medium enclosure 130 and the lasing medium supply reservoir 124 may be arranged in a spaced apart relation or they may be arranged in a nested relation.

In one embodiment, the fluid connection 128 comprises a tube having a first end connected to the fluid outlet 126 of the lasing medium supply reservoir 124 and a second end connected to the fluid inlet 122 of the lasing medium enclosure 120, as best illustrated in FIG. 11. Fluid seals 130a, 130b are associated with the respective first and second ends of the tube. The tube may comprise a rigid material.

In lieu of a tube, the fluid connection 128′ may be defined by the fluid inlet 122 and the fluid outlet 126 being positioned in an end-to-end relation with a fluid seal 130a positioned therebetween, as best illustrated in FIGS. 12 and 13. The lasing medium enclosure 120 and the lasing medium supply reservoir 124 in the laser assembly 118′ may be arranged in a spaced apart relation as illustrated in FIG. 12. Alternatively, the lasing medium enclosure 120 and the lasing medium supply reservoir 124 in the laser assembly 118″ may be arranged in a nested relation as illustrated in FIG. 13. The fluid seals 130a, 130b may comprise an o-ring, an adhesive or a heat softenable metal material. The o-ring may include rubber, plastic or metal, for example. The heat softenable metal material may include brazed, soldered or welded metal or metal alloys.

Another aspect of the present invention is directed to a method for making a laser assembly 118 comprising providing a lasing medium enclosure 120 containing a lasing medium and comprising a fluid inlet 122, coupling a pumping source 10 to the lasing medium enclosure for stimulating the lasing medium, and providing a lasing medium supply reservoir 124 storing a quantity of the lasing medium therein and comprising a fluid outlet 126. The method further comprises establishing a fluid connection 128 between the fluid inlet 122 and the fluid outlet 126 and using at least one fluid seal 130a associated therewith.

Many modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. A laser assembly comprising:
a lasing medium enclosure for containing a lasing medium and comprising a fluid inlet;
a pumping source for stimulating the lasing medium within said lasing medium enclosure;
a lasing medium supply reservoir storing a quantity of the lasing medium therein and comprising a fluid outlet;
a fluid connection between the fluid inlet and the fluid outlet; and
at least one fluid seal associated with said fluid connection.

2. A laser assembly according to claim 1, wherein said lasing medium enclosure further comprises a mirror mount having a passageway therethrough, and a lasing medium tube having an open end connected in fluid communication with a first end of the passageway so that a second end of the passageway defines the fluid inlet.

3. A laser assembly according to claim 1, wherein said fluid connection comprises a tube having a first end connected to the fluid outlet and a second end connected to the fluid inlet; and wherein said at least one fluid seal comprises first and second fluid seals associated with the respective first and second ends of said tube.

4. A laser assembly according to claim 3, wherein said tube comprises rigid material.

5. A laser assembly according to claim 1, wherein said fluid connection is defined by the fluid inlet and the fluid outlet being positioned in an end-to-end relation with said at least one fluid seal positioned therebetween.

6. A laser assembly according to claim 1, wherein said at least one fluid seal comprises an o-ring.

7. A laser assembly according to claim 1, wherein said at least one fluid seal comprises adhesive.

8. A laser assembly according to claim 1, wherein said at least one fluid seal comprises a heat softenable metal material.

9. A laser assembly according to claim 1, wherein said lasing medium enclosure comprises a first material and said lasing medium supply reservoir comprises a second material different than the first material.

10. A laser assembly according to claim 1, wherein said lasing medium enclosure and said lasing medium supply reservoir are arranged in spaced apart relation.

11. A laser assembly according to claim 1, wherein said lasing medium enclosure and said lasing medium supply reservoir are arranged in nested relation.

12. A laser assembly according to claim 1, wherein the lasing medium comprises at least one of a gas and a liquid.

13. A laser assembly according to claim 1, further comprising a cooling structure thermally coupled to said lasing medium enclosure, said cooling structure comprising at least one cooling fluid inlet and at least one cooling fluid outlet at different locations along said lasing medium enclosure.

14. A laser assembly comprising:
a lasing medium enclosure for containing a lasing medium and comprising
a mirror mount having a passageway therethrough, the passageway having first and second ends,
a lasing medium tube having an open end connected in fluid communication with the first end of the passageway so that the second end of the passageway defines a fluid inlet, and
a mirror carried by said mirror mount;
a pumping source for stimulating the lasing medium within said lasing medium enclosure;
a lasing medium supply reservoir storing a quantity of the lasing medium therein and comprising a fluid outlet;
a fluid connection between the fluid inlet and the fluid outlet; and
at least one fluid seal associated with said fluid connection.

15. A laser assembly according to claim 14, wherein said fluid connection comprises a tube having a first end connected to the fluid outlet and a second end connected to the fluid inlet; and wherein said at least one fluid seal comprises first and second fluid seals associated with the respective first and second ends of said tube.

16. A laser assembly according to claim 15, wherein said tube comprises rigid material.

17. A laser assembly according to claim 14, wherein said fluid connection is defined by the fluid inlet and the fluid outlet being positioned in an end-to-end relation with said at least one fluid seal positioned therebetween.

18. A laser assembly according to claim 14, wherein said at least one fluid seal comprises an o-ring.

19. A laser assembly according to claim 14, wherein said at least one fluid seal comprises adhesive.

20. A laser assembly according to claim 14, wherein said at least one fluid seal comprises a heat softenable metal material.

21. A laser assembly according to claim 14, wherein said lasing medium enclosure comprises a first material and said lasing medium supply reservoir comprises a second material different than the first material.

22. A laser assembly according to claim 14, wherein said lasing medium enclosure and said lasing medium supply reservoir are separate and spaced apart.

23. A laser assembly according to claim 14, wherein said lasing medium enclosure and said lasing medium supply reservoir are nested together.

24. A laser assembly according to claim 14, wherein the lasing medium comprises at least one of a gas and a liquid.

25. A laser assembly according to claim 14, further comprising a cooling structure thermally coupled to said lasing medium enclosure, said cooling structure comprising at least one cooling fluid inlet and at least one cooling fluid outlet at different locations along said lasing medium enclosure.

26. A laser assembly comprising:
a lasing medium enclosure for containing a lasing medium and comprising a fluid inlet;
a pumping source for stimulating the lasing medium within said lasing medium enclosure;
a lasing medium supply reservoir storing a quantity of the lasing medium therein and comprising a fluid outlet;
a tube having a first end connected to the fluid outlet and a second end connected to the fluid inlet; and
first and second fluid seals associated with the respective first and second ends of said tube.

27. A laser assembly according to claim 26, wherein said tube comprises rigid material.

28. A laser assembly according to claim 26, wherein said lasing medium enclosure further comprises a mirror mount having a passageway therethrough and a lasing medium tube having an open end connected in fluid communication with a first end of the passageway so that a second end of the passageway defines the fluid inlet.

29. A laser assembly according to claim 26, wherein each fluid seal comprises an o-ring.

30. A laser assembly according to claim 26, wherein each fluid seal comprises adhesive.

31. A laser assembly according to claim 26, wherein each fluid seal comprises a heat softenable metal material.

32. A laser assembly according to claim 26, wherein said lasing medium enclosure comprises a first material and said lasing medium supply reservoir comprises a second material different than the first material.

33. A laser assembly according to claim 26, wherein said lasing medium enclosure and said lasing medium supply reservoir are separate and spaced apart.

34. A laser assembly according to claim 26, wherein the lasing medium comprises at least one of a gas and a liquid.

35. A laser assembly according to claim 26, further comprising a cooling structure thermally coupled to said lasing medium enclosure, said cooling structure comprising at least one cooling fluid inlet and at least one cooling fluid outlet at different locations along said lasing medium enclosure.

36. A method for making a laser assembly comprising:
providing a lasing medium enclosure containing a lasing medium and comprising a fluid inlet;
coupling a pumping source to the lasing medium enclosure for stimulating the lasing medium;
providing a lasing medium supply reservoir storing a quantity of the lasing medium therein and comprising a fluid outlet; and
establishing a fluid connection between the fluid inlet and the fluid outlet and using at least one fluid seal associated therewith.

37. A method according to claim 36, wherein the lasing medium enclosure further comprises a mirror mount having a passageway therethrough and a lasing medium tube having an open end connected in fluid communication with a first end of the passageway so that a second end of the passageway defines the fluid inlet.

38. A method according to claim 36, wherein the fluid connection comprises a tube having a first end connected to the fluid outlet and a second end connected to the fluid inlet; and wherein the at least one fluid seal comprises first and second fluid seals associated with the respective first and second ends of the tube.

39. A method according to claim 38, wherein the tube comprises rigid material.

40. A method according to claim 36, wherein the fluid connection is defined by the fluid inlet and the fluid outlet being positioned in an end-to-end relation with the at least one fluid seal positioned therebetween.

41. A method according to claim 36, wherein the at least one fluid seal comprises an o-ring.

42. A method assembly according to claim 36, wherein the at least one fluid seal comprises adhesive.

43. A method assembly according to claim 36, wherein the at least one fluid seal comprises a heat softenable metal material.

44. A method according to claim 36, wherein the lasing medium enclosure comprises a first material and the lasing medium supply reservoir comprises a second material different than the first material.

45. A method according to claim 36, wherein the lasing medium enclosure and the lasing medium supply reservoir are separate and spaced apart.

46. A method according to claim 36, wherein the lasing medium enclosure and the lasing medium supply reservoir are nested together.

47. A method according to claim 36, wherein the lasing medium comprises at least one of a gas and a liquid.

48. A method according to claim 36, further comprising thermally coupling a cooling structure to the lasing medium enclosure, the cooling structure comprising at least one cooling fluid inlet and at least one cooling fluid outlet at different locations along the lasing medium enclosure.
